(19) United States
(12) Patent Application Publication
(10) Pub. No.: US 2013/0006849 A1
(43) Pub. Date: Jan. 3, 2013

(54) LOCATION BASED SERVICES

(75) Inventor: Paul Morris, Cambridge (GB)

(73) Assignee: Cambridge Silicon Radio Limited, Cambridge (GB)

(21) Appl. No.: 13/536,015

(22) Filed: Jun. 28, 2012

(30) Foreign Application Priority Data
Jun. 28, 2011 (GB) 1110960.0

(51) Int. Cl. G06Q 20/32; H04B 7/26; H04B 5/02; H04W 24/00; H04W 88/06

(52) U.S. Cl. 705/39; 455/456.1

(57) ABSTRACT

A mobile device, comprising a Bluetooth system capable of establishing wireless Bluetooth communications, and also receiving Wi-Fi and/or GPS signals; an NFC communication system capable of establishing wireless NFC communications with a remote NFC device; and a processing system in communication with the Bluetooth system and the NFC system, the processing system configured to determine the location of the mobile device and conduct transactions utilising the NFC system.

### CROSS-REFERENCE TO RELATED APPLICATIONS

This application claims priority to U.K. Patent Application Serial No. 1110960.0 filed on Jun. 28, 2011, the contents of which are incorporated herein by reference.

### BACKGROUND

Apparatus and methods for providing location-based services with wireless communication systems are described.

Many mobile devices are equipped with location-determination systems such that the device has an awareness of its location. Many methods of determining location are possible, for example satellite-oriented systems such as GPS or systems utilising known wireless (typically Wi-Fi) base-station locations.

Mobile devices are commonly equipped with dedicated hardware to provide the location determination system. For example, a GPS receiver may be provided to receive and decode location information, or a Wi-Fi system may be utilised to communicate with Wi-Fi base stations to provide data services and/or location information as well as location determination.

However, these location systems typically require custom hardware to implement, and require significant power to run, both of which are disadvantageous for use in mobile consumer devices.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

There is provided a mobile device, comprising a Bluetooth system capable of receiving Wi-Fi and/or GPS signals; an NFC communication system capable of establishing wireless NFC communications with a remote NFC device; and a processing system in communication with the Bluetooth system and the NFC system, the processing system configured to determine the location of the mobile device and conduct transactions utilising the NFC system.

The Bluetooth system and the NFC system may be integrated.

There is also provided a method of conducting transactions utilising a mobile device, the method comprising the steps of ascertaining the location of the mobile device utilising non-Bluetooth signals received by a Bluetooth system of the mobile device, receiving electronic vouchers or information at the mobile device; and conducting a transaction utilising the NFC system and altering the transaction depending on the received vouchers or information.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a schematic diagram of a mobile device; and

FIG. 2 shows a flow chart of a method utilising the device of FIG. 1.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

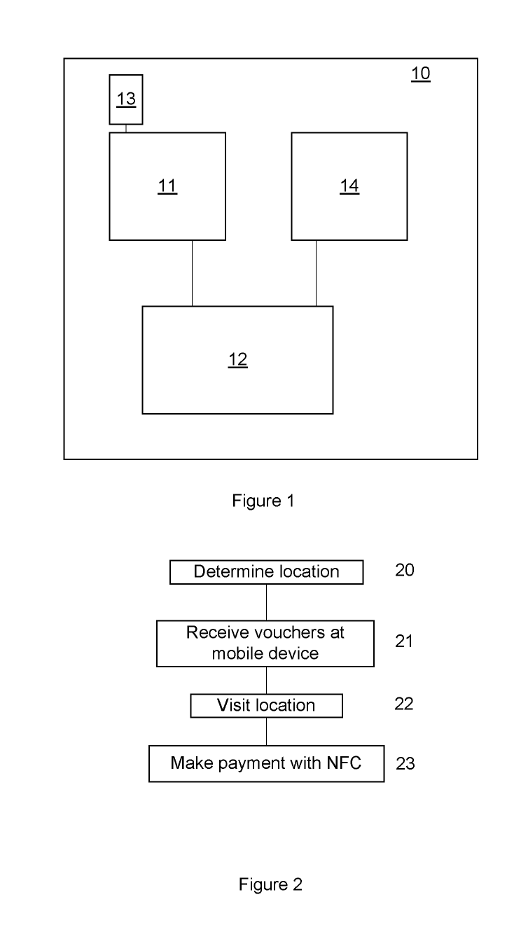

FIG. 1 shows a schematic block diagram of a mobile device 10 providing a location-determination system and a wireless communication system to enable the efficient provision of location-based services. A Bluetooth system 11 is interfaced to a processing system 12, and is equipped with an antenna system 13. Antenna system 13 is configured to enable the Bluetooth system to receive not only Bluetooth transmissions, but also selected parts of GPS satellite transmissions, and Wi-Fi transmissions (not necessarily simultaneously with each other or with Bluetooth usage). For example, Bluetooth receivers, with a suitably configured antenna system, can receive the GPS L1 band and demodulate the signals. Similarly, a Bluetooth receiver can receive and demodulate a Wi-Fi signal. Mobile device 10 is also provided with a mobile telephone system for providing conventional telephony services, and optionally data services via the mobile telephone infrastructure.

Processing system 12 receives demodulated data from the Bluetooth system 11 which may be processed according to the programming of that system. For example, the processing system 12 may be programmed to provide software GPS functions to calculate the location of the device. Similarly, Wi-Fi signals may be processed to determine the access point's ID, and hence allow location determination via a look-up system. The look-up system may utilise a data connection, for example via a mobile telephone link, to access look-up tables with base station location, or that information may be stored locally. Furthermore, location may be determined utilising a mobile telephony connection and the known location of one or base station with which that connection is established. Utilising one or more of these methods may reduce the complexity and cost of the mobile device, and may reduce power consumption when determining location. For example, an entire GPS receiver is not required, but the Bluetooth receiver may be utilised instead. Similarly, a whole Wi-Fi system is not required, but the Bluetooth system may enable sufficient decoding and processing of the signals to determine location. Power efficiency is improved as, for example, Wi-Fi receivers consume significant power even when in stand-by mode, whereas Bluetooth receivers are more efficient.

An NFC communication system 14 is also interfaced to processing system 12 and is provided to allow NFC communications with remote devices. For example, NFC communications may be utilised for payment services.

The Bluetooth system 11, processing system 12, and NFC system 14 may be integrated in a single component, or two or more of those systems may be integrated (for example a combined Bluetooth and NFC device). Such integration is intended to reduce costs and complexity by reducing the number of discrete components required to provide a given functionality.

FIG. 2 shows a flow-chart of a method implemented utilising the mobile device of FIG. 1. At block 20 a mobile device ascertains its location as discussed previously. At block 21 the mobile device receives vouchers or information dependent on the location of the device. For example, the device may determine it is close to a particular type of coffee chain by identifying a Wi-Fi signal (utilising the Bluetooth receiver) associated with that chain's free Wi-Fi provision. Any method of locating proximity may be utilised, for example look-up systems based on mapping resources or company's published locations.

At block 22 the user decides to visit the outlet to which the voucher or information applies and at block 23 makes a purchase utilising the NFC system of the mobile device to pay for the produce or service. The mobile device (and the payment system generally) matches the payment to the voucher received at block 21, and applies the appropriate savings or variation to the purchase.

The provision of a mobile device with a location-determination system and an NFC communication system thereby enables the efficient provision of location-based services. The utilisation of a Bluetooth system to determine location, and the integration of an NFC system with other systems, reduces the complexity and cost of the mobile device thereby making it more attractive to consumers.

The terms ‘computer’ or ‘processing system’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants, set-top boxes and many other devices. The term ‘website’ is not intended to require that the website is related wholly or even in part to the sale of goods or services. The party identified as the website could equally operate their website or system to facilitate other transactions or services, not necessarily in return for direct payment or reward. The systems and methods described herein are therefore not restricted to conventional trading entities, but are also applicable to any party providing financial services using a third party.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention.

Although various embodiments of the invention have been described above with a certain degree of particularity, or with reference to one or more individual embodiments, those skilled in the art could make numerous alterations to the disclosed embodiments without departing from the spirit or scope of this invention.

The term ‘image’ does not restrict the display to displaying static images, but encompasses any displayed visual content, including TV and computer displays etc.

1. A mobile device, comprising
a Bluetooth system capable of receiving Wi-Fi and/or GPS signals;
an NFC communication system capable of establishing wireless NFC communications with a remote NFC device; and
a processing system in communication with the Bluetooth system and the NFC system, the processing system configured to determine the location of the mobile device and conduct transactions utilising the NFC system.

2. A mobile device according to claim 1 wherein the Bluetooth system and the NFC system are integrated.

3. A method of conducting transactions utilising a mobile device, the method comprising the steps of
ascertaining the location of the mobile device utilising non-Bluetooth signals received by a Bluetooth system of the mobile device,
receiving electronic vouchers or information at the mobile device; and
conducting a transaction utilising the NFC system and altering the transaction depending on the received vouchers or information.
